(19) United States
(12) Patent Application Publication
(10) Pub. No.: US 2026/0327865 A1
(43) Pub. Date: Oct. 22, 2026

(54) Fabric with Moisture Management Function

(71) Applicant: LULULEMON ATHLETICA CANADA INC., Vancouver (CA)

(72) Inventors: Yogendra V. Dandapure, Vancouver (CA); Sealgi Song, Vancouver (CA)

(21) Appl. No.: 19/725,237

(22) Filed: Jun. 30, 2026

Related U.S. Application Data
(63) Continuation of application No. 18/248,323, filed on Dec. 22, 2021, now Pat. No. 12,703,933.
(60) Provisional application No. 63/129,705, filed on Dec. 23, 2020.

(51) Int. Cl. D03D 15/527; B32B 5/02; B32B 5/06; B32B 5/08; B32B 5/26; B32B 7/02; D03D 1/00; D03D 11/00; D03D 13/00; D03D 15/217; D03D 15/225; D03D 15/283; D03D 15/292; D03D 15/47; D03D 15/54; D04B 1/14; D04B 1/16; D04B 1/24; D04B 21/16; D04B 21/20

(52) U.S. Cl. CPC D03D 15/527; B32B 5/024; B32B 5/026; B32B 5/073; B32B 5/08; B32B 5/26; B32B 5/263; B32B 7/02; D03D 1/00; D03D 11/00; D03D 13/004; D03D 15/217; D03D 15/225; D03D 15/283; D03D 15/292; D03D 15/47; D03D 15/54; D04B 1/14; D04B 1/16; D04B 1/24; D04B 21/16; D04B 21/207; B32B 2262/0261; B32B 2262/0292; B32B 2262/04; B32B 2262/062; B32B 2262/148; B32B 2262/152; B32B 2307/728; B32B 2437/00; D10B 2201/02; D10B 2201/20; D10B 2331/02; D10B 2331/10; D10B 2401/022; D10B 2403/0114; D10B 2501/00

(57) ABSTRACT

A knitted/woven fabric with moisture management function including a first fabric layer having a first yarn and a second yarn knitted together to form a first layer being semi-hydrophilic or hydrophobic (comprising of lower moisture regain fibers), a second fabric layer comprising a third yarn and a fourth yarn knitted together to form the second fabric layer, the second fabric layer being fully hydrophilic (comprising of higher moisture regain fibers). The first fabric layer has a moisture regain lower than the moisture regain of the second fabric layer providing a hydrophilic gradient between the first fabric layer and the second fabric layer of the knitted fabric pushing moisture through the first fabric layer in contact with the wearer's skin and out through the second fabric layer.

### CROSS-REFERENCE TO RELATED APPLICATIONS

The present application is a continuation of and claims benefit of U.S. application Ser. No. 18/248,323 filed on Apr. 7, 2023 and titled “Fabric with Moisture Management Function,” which application was a 371 national stage application of PCT/CA2021/051872 filed on Dec. 22, 2021, which claims benefit of U.S. Provisional Application No. 63/129,705 filed Dec. 23, 2020, the contents of which applications are hereby incorporated by reference in their entirety.

### TECHNICAL FIELD

It is provided a knitted and a woven fabric with moisture management function comprising a hydrophilic gradient.

### BACKGROUND

Fabrics used in apparel designed for athletic activities are conceived with the objective of maximizing the body performance by notably controlling the body temperature and keeping the moisture away from the individual in order to reduce the quantity of perspiration that accumulates adjacent to the skin, which causes discomfort with wet cling and increases friction with skin causing chafing The challenge is to manufacture such apparel which generally exhibit characteristics that enhance the performance without compromising the appearance and/or comfort of an individual.

The nature of the textiles that are incorporated into an apparel are generally selected based upon the targeted property for which the apparel is conceived, such as for example wind resistance, reduction of perspiration that accumulates adjacent to the skin, and enhancing comfort of individuals engaged in specific athletic activities.

Textiles normally incorporated in such fabrics may be cotton, wool, silk, synthetic materials such as rayon, nylon, polyester, and polyacrylic for example.

There is always a challenge to provide athletes when competing or training, with improved apparel which will allow to cope with heat/cold from the external environment, but also with heat generated within the body of the athlete as a result of physical exertion and associated sweat and lack of heat dissipation.

It is thus highly desired to be provided with improved fabrics.

### SUMMARY

It is provided a knitted or woven fabric with moisture management function comprising a first fabric layer comprising a first yarn to form the first layer being semi-hydrophilic with lower moisture regain and a second fabric layer comprising a second yarn, the second fabric layer being hydrophilic with higher moisture regain, wherein the first fabric layer has a moisture regain lower than the moisture regain of the second fabric layer providing a hydrophilic gradient between the first fabric layer and the second fabric layer of the knitted/or woven fabric pulling moisture through the first fabric layer and pushing it out through the second fabric layer.

The proposed combination of yarns and total moisture regain of the fabric provides optimum comfort to the wearer by making sure that excess sweat does not accumulate next to skin while still provide moisture in the fabric that would help in cooling and breathability.

In an embodiment, the fabric is a weft or warp knitted fabric or a woven fabric.

In an embodiment, the moisture regain of the first fabric layer is in the range of 0.2%-6% and the moisture regain of the second fabric layer is in the range of 4%-16%, and the moisture regain gradient is greater than 3%.

In a further embodiment, the first yarn is selected from a group consisting of a nylon, a polyester, a polypropylene, an acrylic, cotton, wool, silk, regenerated cellulosic fibers and any blend combination thereof.

In an embodiment, the first fabric layer further comprises a third yarn joined together with the first yarn and the second fabric layer further comprises a forth yarn joined together with the second yarn.

In a supplemental embodiment, the third yarn is a synthetic polymer.

In another embodiment, the first fabric layer is a composite blend of a synthetic polymer plaited with an elastane.

In an embodiment, the second yarn comprises a natural or a regenerated cellulosic fiber or a blend of natural or regenerated cellulosic fibers with synthetic fibers such as nylon, a polyester, a polypropylene, an acrylic.

In another embodiment, the second yarn is selected from the group consisting of a cotton, silk, wool, modal, micro-modal, rayon, lyocell, viscose, cupro, artificial silk, nylon, a polyester, a polypropylene, an acrylic and any combination thereof.

In a further embodiment, the fourth yarn is a synthetic polymer.

In an embodiment, the fourth yarn is an elastane.

In another embodiment, the second fabric layer is a composite blend of a natural fiber plaited with an elastane or a blend of natural fiber and synthetic fiber such as nylon, a polyester, a polypropylene, or an acrylic.

In an embodiment, the second yarn is a synthetic polymer.

In another embodiment, the second yarn is selected from a group consisting of a nylon, a polyester, a polypropylene, an acrylic or blended with cotton, silk, wool, modal, micro-modal, rayon, lyocell, viscose, cupro, artificial silk and a combination thereof.

In a further embodiment, the second fabric layer is pitched to increase its surface area.

In a supplemental embodiment, the fabric is knitted and further comprises a connecting yarn binding together the first and the second fabric layers.

In an embodiment, the connecting yarn is at least a single strand.

In an embodiment, the connecting yarn is an elastane.

In a further embodiment, the connecting yarn is a synthetic polymer.

In another embodiment, the connecting yarn is a natural fiber.

In an embodiment, the connecting yarn is a zig-zag structure between the first fabric layer and the second fabric layer. It is understood that the zig-zag structure means mainly a lapping back and forth between first and second layer fabrics in order to connect them.

In a supplemental embodiment, the fabric is knitted from a single jersey plaited construction, a double jersey plaited construction, a tricot or warp knit construction.

In an embodiment, at least one of the first yarn, the second yarn, the third yarn and the fourth yarn is produced by compact spinning.

In an embodiment, the first fabric layer and the second fabric layer are woven with a number of yarn cross overs desired.

In a further embodiment, the yarn cross over is of 3 up and 3 down, 3 up and one down, 3 up and 2 down, or 4 up and 1 down.

It is further provided an article of apparel comprising the fabric as defined herein.

### BRIEF DESCRIPTION OF THE DRAWINGS

Reference Will Now Be Made to the Accompanying Drawings.

FIG. 1 illustrates a schematic representation of a double jersey plaited construction fabric as encompassed herein in accordance to an embodiment.

FIG. 2 illustrates a schematic representation of a single jersey plaited construction fabric in accordance to another embodiment.

FIG. 3 illustrates a compact spinning technique used for the fabrication of the yarns as encompassed herein.

FIG. 4A illustrates the outer layer a fabric in accordance to an embodiment.

FIG. 4B illustrates the inner layer of the fabric shown in FIG. 4A in accordance to an embodiment.

FIG. 5 illustrates a schematic representation of a double woven construction fabric as encompassed herein in accordance to an embodiment.

FIG. 6 illustrates a schematic representation of a plaited tricot (warp) knitted construction fabric as encompassed herein in accordance to an embodiment.

### DETAILED DESCRIPTION

In accordance with the present disclosure, it is provided a knitted or woven fabric with moisture management function comprising a first fabric layer comprising a first yarn and forming a next to skin back fabric layer, the first fabric layer having a first moisture regain and being a semi-hydrophilic or hydrophobic layer and a second fabric layer comprising a second yarn forming a face fabric layer facing towards outside, the second fabric layer having a second moisture regain and being a hydrophilic layer. In case of a knitted fabric, it can further comprise a connecting yarn binding together the first fabric layer and the second fabric layer.

As described herein, the moisture from a wearer's skin is pushed through the first fabric layer and pulled out through the second fabric layer due to the presence of a moisture regain gradient between the first fabric layer and the second fabric layer of the knitted fabric.

In an embodiment, the moisture regain of the first fabric layer is in the range of 0.2%-6% while the moisture regain of the second fabric layer is in a range of 4%-16% and the moisture regain gradient between the two fabric layers is greater than 3%. For example, the moisture regain gradient between the two fabric layers is greater than 3%, such as e.g. between 3%-15%.

As seen in FIG. 1, the fabric 10 comprises a first layer 12 which is the layer next to the skin A (inner layer) and a second layer 14 which correspond to the layer of the fabric 10 facing the exterior B (outer layer) and away from the skin A. As illustrated in FIG. 1, in an embodiment, a connecting yarn 16 binds together the first fabric layer 12 and the second fabric layer 14 tightening the fabric 10 together. The moisture from a wearer's skin is pushed through the first fabric layer 12 towards the second fabric layer 14. The presence of a hydrophilic (moisture regain) gradient between the first fabric layer 12, being a semi-hydrophilic layer, and the second fabric layer 14, representing a hydrophilic layer, of the fabric 10 allows the moisture to be pushed as indicated from the direction of the arrow between region A of the skin towards exterior region B.

The first fabric layer 12 in an embodiment comprises a first yarn 18 and the second fabric layer 14 comprises a second yarn 23. In the illustrated embodiment of FIG. 1, the first fabric layer 12 further comprises a third yarn 20 knitted or woven together to form the next to skin A inner fabric layer 12, the first fabric layer 12 being a semi-hydrophilic or hydrophobic layer as mentioned. It is encompassed that the first yarn 18 and the third yarn 20 are a synthetic polymer, such as for example but not limited to, a polyester, a polypropylene, an acrylic, a polyacrylic or any combination thereof. As illustrated herein, the third yarn 20 is an elastane, resulting in a first fabric layer 12 being a composite blend of a synthetic polymer plaited with an elastane. In one embodiment, the first yarn 18 can be a composite of synthetic polymer and natural fiber such as for example, cotton, wool, silk or regenerated cellulosic fibers and can be configured as semi-hydrophilic with a first moisture regain. For example the first yarn 18 can be a blend of 70-95% synthetic polymer (e.g., polyester) and 5-30% natural fibers (e.g., cotton).

The second fabric layer 14 further comprises a fourth yarn 24 knitted or woven together to form a face (outer) fabric layer 14 facing towards outside B, the second fabric layer 14 being a hydrophilic layer. As encompassed, the second yarn 23 comprises a natural fiber, such as for example and not limited to, a cotton, silk, wool, modal, micro-modal, rayon, lyocell, viscose or a combination thereof. The second yarn 23 can alternatively be a composite blend of a modal and a cotton. Alternatively, the second yarn can also be a synthetic polymer such as for example a nylon, a polyester, a polypropylene, an acrylic, a polyacrylic or a combination thereof. The fourth yarn 24 can be a synthetic polymer, such as elastane. As a further embodiment, it is encompassed a second fabric layer 14 comprising a composite blend of a natural fiber plaited with an elastane. In one embodiment, the second yarn 23 is a composite blend of natural or regenerated cellulosic fiber and synthetic fiber such as nylon, a polyester, a polypropylene, an acrylic. One means to increase the hydrophilic nature of the second layer 14 is to increase its surface area. Accordingly, it is encompassed that the second fabric layer 14 can be pitched to increase its surface area.

The connecting yarn 16 binding together the first fabric layer 12 and the second fabric layer 14 is at least a single strand. As encompassed herein, the connecting yarn 16 is an elastane. It is also encompassed that the connecting yarn 16 is a synthetic polymer such as for example a nylon, a polyester, a polypropylene, an acrylic, a polyacrylic or a combination thereof. Alternatively, the connecting yarn 16 as described herein can comprise preferably a natural fiber such as for example a cotton, silk, wool, modal, micro-modal, rayon, lyocell, viscose or a combination thereof. The connecting yarn is preferably a zig-zag structure (an overlap) between the first fabric layer 12 and the second fabric layer 14. It is encompassed that the zig-zag structure consist of a lapping back and forth between first and second layer fabrics in order to connect them (FIG. 6). The connecting yarn 16 can be single strand or multiple strands. Each strand of the plurality of strands of the connecting yarn 16 can have independent zig-zag (underlap and overlap) structure.

It is thus described a fabric construction comprising an hydrophilic side and a semi hydrophilic or hydrophobic side allowing maximum moisture control. The fabric describe herein has the characteristic to push the moisture by a hydrophilic gradient using semi-hydrophilic and fully-hydrophilic layers next to each other. The combination of potentially 4 different types of fibers and the semi-hydrophilic or hydrophobic and fully-hydrophilic surfaces next to each other allows for efficient moisture management and quick drying.

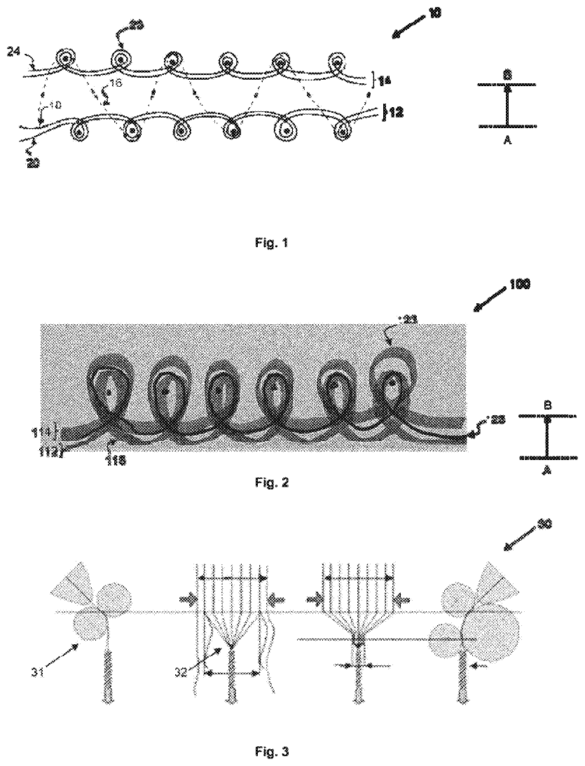

As described herein, in some embodiments, the described fabric is made with a knitting construction which can be a weft knitted or wrap knitted structure. For example, the fabric can be a single jersey plaited construction (see FIG. 2) or a double jersey plaited construction for example (see FIG. 1) or Tricot warp knit plaited structure. As illustrated in FIG. 2, the fabric 100 has a single jersey plaited construction with a first layer 112 that comprises a first yarn 118 having the first moisture regain and a second layer 114 that comprises a second yarn 123 with the second moisture regain. The first moisture regain is lower than the second moisture regain providing a hydrophilic gradient between the first fabric layer 112 and the second fabric layer 114 of the fabric 100 thus pushing the moisture through the first fabric layer 112 and out through the second fabric layer 114. The fabric 100 further comprising a plaited yarn 125. The plaited yarn 125 can be elastane to increase the elasticity of the fabric 100.

In an embodiment, the moisture regain of the first fabric layer is in the range of 0.2%-6% and the moisture regain of the second fabric layer is in the range of 4%-16% and the moisture regain gradient between the two fabric layers is greater than 3%.

In an embodiment, at least one of the first, second, third or fourth yarn are fabricated using a compact spinning technique to spin the cotton/micromodal yarn for example that helps reducing pilling and better handfeel.

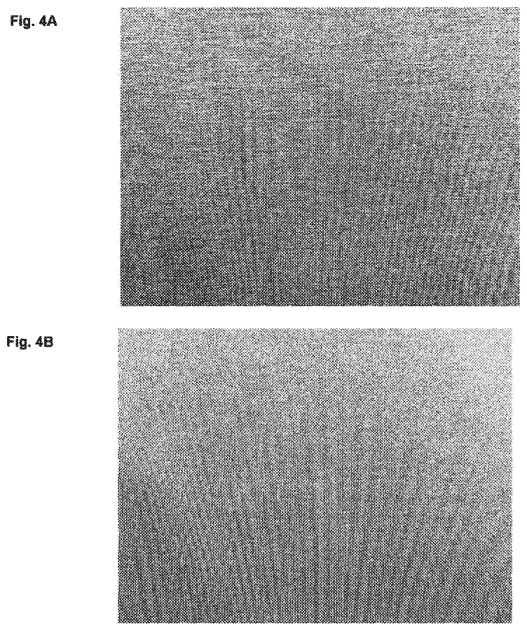

As seen in FIG. 3, in traditional spinning machines, such as ring spinner 31, the fiber stream is twisted without first being brought close together by compressing it (compacting) and the resulting yarn may pill or feel rough due to the broad twisting triangle 32 formed before the fibers are twisted. Compact spinning 30 involves narrowing and decreasing the width of the band of fibers (b_{comp}) so that it is much narrower than the width of the fibers band (b_{ring}) in the ring spinning 31 (see FIG. 3). Such compacted fibers band is then twisted into a yarn, and the x twisting triangle is eliminated. Compacting the fiber stream first causes the fiber stream in the form of the flat band of fibers to be condensed into a compact fiber stream with increased frictional contact points between the fibers. Compact spinning allows to produce compact yarns. Thus, compact spinning is a process where fiber strand drawn by drafting system is condensed before twisting it.

In some embodiment, at least one of the first, second, third or fourth yarn are fabricated using a ring spinning technique, such as Sirospun™, core spun, compact spun where one yarn can be a natural fiber and the other yarn can be a synthetic fiber. Any other spinning technique (e.g. air jet spinning, ring spinning, mule spinning) can be used without departing from the scope of the invention.

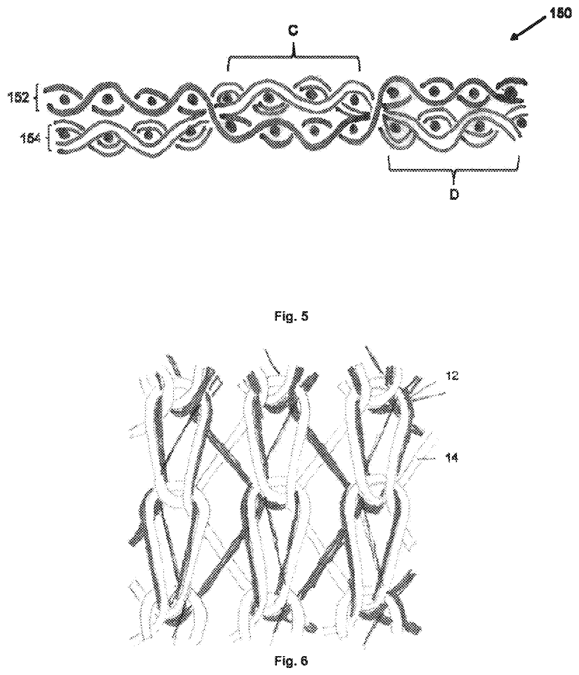

FIG. 4 provides a picture of a fabric comprising 26% cotton and 26% modal forming the outer layer with higher moisture regain fibers in A), and 25% elastane and 23% nylon forming an inner layer with lower moisture regain allowing and moisture management as described herein.

FIG. 5 illustrates an example of fabric construction that is double weave 150. The first 152 and the second layers 154 are woven in order to keep one fabric to one side in a way that the number of yarn cross overs is reduced. For example, in the illustrated example of fabric construction in FIG. 5, the cross over is 3 up C and 3 down D but it can be a sequence of 3 up and one down, 3 up and 2 down, or 4 up and 1 down etc.

As encompassed herein, the knitted fabric described herein with moisture management can be any type of articles of apparel including shirts, headwear, coats, jackets, pants, underwear, gloves, socks, and footwear.

While the disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims.

1. A fabric with moisture management function comprising:
an inner fabric layer intended to be the layer next to the skin of a wearer of the fabric,
the inner fabric layer comprising a first yarn with a first moisture regain;
an outer fabric layer intended to face the exterior so that the inner fabric layer is arranged between the outer fabric layer and the skin of a wearer of the fabric, the outer fabric layer comprising a second yarn with a second moisture regain;
the second moisture regain of the outer fabric layer is greater than the first moisture regain of the inner fabric layer by more than 3% so as to act to pull moisture through the inner fabric layer and push the moisture out through the outer fabric layer.

2. The fabric of claim 1, wherein the first moisture regain of the inner fabric layer is in the range of 0.2%-6%.

3. The fabric of claim 1, wherein the second moisture regain of the outer fabric layer is in the range of 4%-16%; preferably wherein the second moisture regain is greater than the first moisture regain by between 3% and 15%.

4. The fabric of claim 1, wherein at least one of the first yarn and the second yarn is a synthetic polymer.

5. The fabric of claim 1, wherein the first yarn is selected from a group of a nylon, a polyester, a polypropylene, an acrylic, cotton, wool, silk, regenerated cellulosic fibers or any blend combination thereof.

6. The fabric of claim 1, wherein the first yarn is a polypropylene.

7. The fabric of claim 1, wherein the second yarn comprises a natural fiber, a regenerated cellulosic fiber or a blend of natural or regenerated cellulosic fibers with synthetic fibers; preferably the synthetic fibers are nylon, a polyester, a polypropylene, an acrylic, or a combination thereof.

8. The fabric of claim 1, wherein the second yarn is a synthetic polymer; preferably the second yarn is selected from a group consisting of a nylon, a polyester, a polypropylene, an acrylic, a blend with cotton, silk, wool, modal, micro-modal, rayon, lyocell, viscose, cupro, and artificial silk, and a combination thereof.

9. The fabric of claim 1, wherein the fabric is a weft or warp knitted fabric or a woven fabric.

10. The fabric of claim 9, wherein the fabric is a weft or warp knitted fabric, and is knitted from a single jersey plaited construction, a double jersey plaited construction, a tricot knit construction, or a warp knit construction.

11. The fabric of claim 9, wherein the fabric is a knitted fabric and further comprises a connecting yarn binding together the inner fabric layer and the outer fabric layer; optionally wherein the connecting yarn is an elastane yarn.

12. The fabric of claim 1, wherein the inner fabric layer further comprises a third yarn knitted or woven together with the first yarn to form the inner layer, and the outer fabric layer further comprises a fourth yarn knitted or woven together with the second yarn to form the outer fabric layer; optionally wherein the third yarn is an elastane yarn, or wherein the fourth yarn is an elastane yarn.

13. An article of apparel comprising a fabric with moisture management function, wherein the fabric is a fabric of claim 1.
